(19) United States
(12) Patent Application Publication
(10) Pub. No.: US 2018/0240061 A1
(43) Pub. Date: Aug. 23, 2018

(54) Intelligent Work Routing

(71) Applicant: MModal IP LLC, Franklin, IN (US)

(72) Inventors: Ian Gransden, Malvern (GB); James Gaskell, Malvern (GB)

(21) Appl. No.: 15/899,447

(22) Filed: Feb. 20, 2018

Related U.S. Application Data
(60) Provisional application No. 62/460,346, filed on Feb. 17, 2017.

(51) Int. Cl. G06Q 10/06; G06F 3/16

(52) U.S. Cl. CPC G06Q 10/063112; G06F 3/167; G06Q 10/063118

(57) ABSTRACT

A computer system uses historical sources of information on transcription work performed by transcriptionists (such as medical transcriptionists) to increase the productivity of such transcriptionists by automatically assigning, to those transcriptionists, transcription work that those transcriptionists are more likely to perform efficiently and effectively, based on the properties of transcription jobs previously performed by the transcriptionists and the quality of the work performed by the transcriptionists on those jobs.

### BACKGROUND

Medical transcriptionists (MTs) are assigned to work pools. As each new transcription job arrives, it is associated with a pool. This process of assigning a job to an MT is referred to as “transcription work routing.” Each pool is typically associated with the type(s) of work that are assigned to it, where such type(s) of work may be associated with a particular set of defined static properties, such as work function (e.g., transcription or quality assurance (QA)), transcription client (e.g., Hospital A or Hospital B), worktypes, dictators (e.g., individual doctors), and priority (e.g., low, medium, or high). Routing may be performed, in whole or in part, by software using a transcription work routing algorithm. Such algorithms may, for example, identify the properties of each incoming transcription job and identify pools having the same or similar properties to the transcription job. Within a group of matching pools, the ordered assignment of jobs is based on priority, where priority may be based on the time remaining until the contracted Turnaround Time (TAT) service level agreement (SLA). As a result, MTs are assigned jobs based solely on which MT is closest to its SLA within the grouping constraints.

In order to satisfy SLAs across various types of work and dictators, it is common for jobs to be assigned to MTs who are not familiar with those jobs. For example, an MT may be assigned a job from a dictator (e.g., doctor) for whom the MT has not previously performed any work, or having a worktype that the MT has not transcribed before. MTs typically are not as productive at transcribing jobs with which they are not familiar. As a result, assigning MTs to jobs with which they are not familiar tends to reduce the quality of the resulting transcriptions.

### SUMMARY

A computer system uses historical sources of information on transcription work performed by transcriptionists (such as medical transcriptionists) to increase the productivity of such transcriptionists by automatically assigning, to those transcriptionists, transcription work that those transcriptionists are more likely to perform efficiently and effectively, based on the properties of transcription jobs previously performed by the transcriptionists and the quality of the work performed by the transcriptionists on those jobs.

Other features and advantages of various aspects and embodiments of the present invention will become apparent from the following description and from the claims.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a dataflow diagram of a system for automatically assigning a transcription job to a transcriptionist according to one embodiment of the present invention.

FIG. 2 is a flowchart of a method performed by the system of FIG. 1 according to one embodiment of the present invention.

### DETAILED DESCRIPTION

In general, embodiments of the present invention automatically and intelligently route transcription jobs to transcriptionists using historical sources of information about the transcription jobs previously performed by those transcriptionists. Embodiments of the present invention provide transcriptionists with jobs that they are more likely to perform efficiently and effectively, thereby increasing the productivity of the transcriptionists and improving the quality of the transcriptions that they produce. In particular, embodiments of the present invention automatically and intelligently route transcription jobs to transcriptionists based on properties of the jobs previously performed by the transcriptionists, the quality of the documents produced by the transcriptionists in those jobs, and the properties of the new transcription jobs to be assigned. Embodiments of the present invention will now be described in more detail.

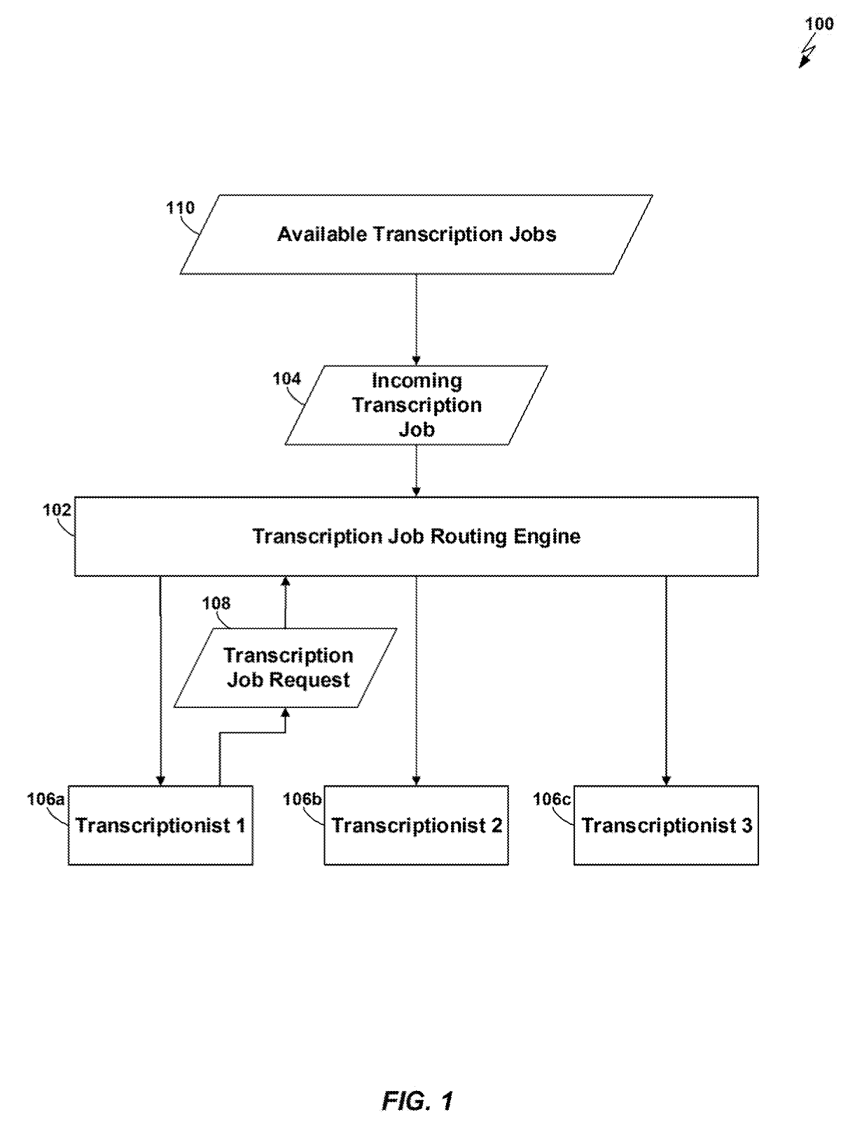

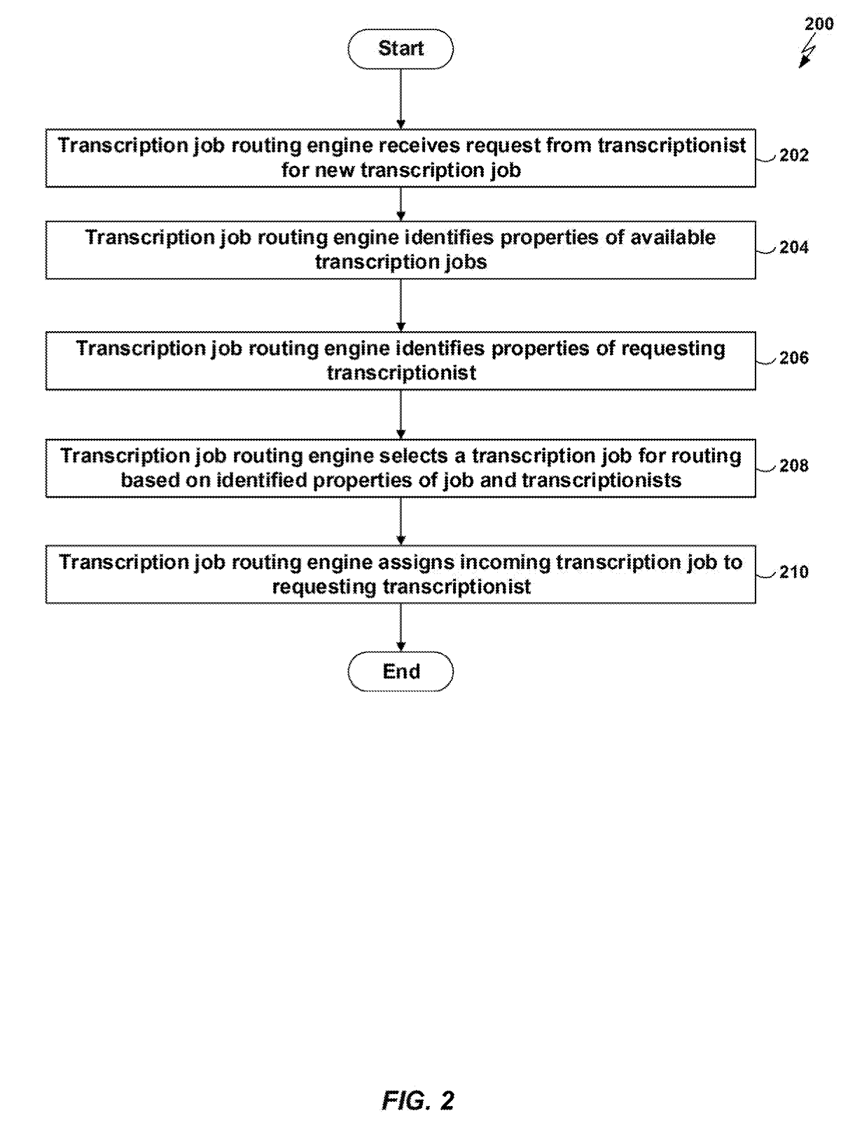

Referring to FIG. 1, a dataflow diagram is shown of a system 100 for automatically assigning a transcription job to a transcriptionist according to one embodiment of the present invention. Referring to FIG. 2, a flowchart is shown of a method 200 performed by the system 100 according to one embodiment of the present invention.

The system 100 of FIG. 1 includes a transcription job routing engine 102, which automatically routes an incoming transcription job 104 to one of a plurality of transcriptionists 106a-c. Although FIG. 1 shows only three transcriptionists 106a-c for ease of illustration, in practice the system 100 may include any number of transcriptionists (e.g., hundreds or thousands of transcriptionists), who may or may not be organized into pools. Although the transcription job routing engine 102 is shown in FIG. 1 as routing the incoming transcription job 104 to an individual transcriptionist, the techniques disclosed herein may be used to route the incoming transcription job 104 to a pool of transcriptionists and/or to an individual transcriptionist within such a pool, where the pool may contain any number of transcriptionists (e.g., one or a plurality of transcriptionists). Therefore, any reference herein to a transcriptionist should be understood to be equally applicable to a pool of transcriptionists. The techniques disclosed herein for routing the incoming transcription job 104 may be applied to any number of transcription jobs.

The incoming transcription job 104 may take any of a variety of forms. For example, the incoming transcription job 104 may include any one or more of the following, in any combination:
An audio signal, such as a live or recorded audio signal, representing the speech of one or more people, stored in an audio file or transmitted (e.g., streamed) to the transcription job routing engine 102 over a digital communication network, such as the Internet.
Additional identifying information regarding the job 104, such as one or more of the following, in any combination:
   a unique identifier of the person who dictated the job 104 (“dictator ID”);
   a unique identifier of the client for whom the job 104 is being performed (“client ID”); and
   data representing a work type of the job 104.

The transcription job routing engine 102 may receive a request 108 from one of the transcriptionists 106a-c to be assigned a new transcription job (FIG. 2, operation 202). In FIG. 1, the transcription job routing engine 102 receives the request from transcriptionist 106a. Any of the transcriptionists 106a-c may, however, provide such a request to the transcription job routing engine 102. The request 108 may be provided to the transcription job routing engine 102 in any of a variety of ways, such as by transmitting it over the Internet or other digital communication network.

The system 100 may contain a set of transcription jobs 110 which are awaiting transcription. The transcription job routing engine 102 may identify one or more properties of one or more of the available transcription jobs 110 (FIG. 2, operation 204). Examples of such properties and ways in which they may be identified will be described in more detail below.

The transcription job routing engine 102 may identify one or more properties of the requesting transcriptionist 106a (FIG. 2, operation 206). Examples of such properties and ways in which they may be identified will be described in more detail below.

The transcription job routing engine 102 may select, based on the identified properties of the incoming transcription job 104 and the identified properties of the available transcriptionists 106a-c, a particular one of the available transcription jobs 110 to assign to the requesting transcriptionist 106a (FIG. 2, operation 208). The selected transcription job is shown as incoming transcription job 104 in FIG. 1. Examples of ways in which the incoming transcription job 104 may be selected will be described in more detail below.

The transcription job routing engine 102 may assign the incoming transcription job 104 to the requesting transcriptionist 106a (FIG. 2, operation 210). This assignment may include, for example, one or both of the following:
storing data (e.g., in a database record) representing information indicating that the incoming transcription job 104 has been assigned to the requesting transcriptionist 106a;
providing (e.g., transmitting over a network) the incoming transcription job 104 and/or information derived therefrom to the requesting transcriptionist 106a; and
removing the incoming transcription job 104 from the set of available transcription jobs 110.

The transcription job routing engine 102 may perform some or all of operations 202-210 automatically, i.e., without human intervention. For example, the transcription job routing engine 102 may receive the transcription job request 108 and, without human intervention, select the transcription job 104 to route to the requesting transcriptionist 106a and provide the incoming transcription job 104 to the requesting transcriptionist 106a.

As mentioned above, the transcription job routing engine 102 may identify properties of one or more of the available transcription jobs 110 (FIG. 2, operation 204). Such properties of a transcription job in the available transcription jobs 110 may include, for example, any one or more of the following, in any combination:
An identity (e.g., name, username, or other identifier) of a person who dictated the audio in the transcription job (referred to herein as the “current dictator”).
The worktype of the transcription job (referred to herein as the “current worktype”). Examples of worktypes include specific document types (e.g., “history and physical” or “discharge note”) and types of medical work (e.g., “radiology” and “pathology”).
The client (e.g., hospital or other healthcare provider) who produced or is otherwise associated with the transcription job (referred to herein as the “current client”).
One or more turnaround time constraints for the transcription job. Such constraints may, for example, be derived from the client and/or worktype of the transcription job. Turnaround time may be defined, for example, as the amount of time between the time at which the transcription job is created and/or received by the transcription job routing engine 102 and when the completed transcript of the transcription job is returned to the client by the system 100.

As mentioned above, the transcription job routing engine 102 may identify properties of the requesting transcriptionist 106a (FIG. 2, operation 206). Such properties may be represented by data stored in the system 100. Such properties may include, for example, any one or more of the following, in any combination:
The amount of experience the requesting transcriptionist 106a has had in connection with transcription jobs dictated by the current dictator, as may be measured by any one or more of the following, in any combination:
   The number of times the requesting transcriptionist 106a has transcribed jobs that were dictated by the current dictator, measured as an absolute number (e.g., 24 jobs) and/or as a percentage of total jobs transcribed by the transcriptionist (e.g., 10%).
   The productivity of the requesting transcriptionist 106a when transcribing jobs that were dictated by the current dictator, such as may be measured by the average number of lines of text produced per hour when the requesting transcriptionist 106a transcribed jobs dictated by the current dictator.
The amount of experience the requesting transcriptionist 106a has had in connection with transcription jobs having the current worktype, as may be measured by any one or more of the following, in any combination:
   The number of times the requesting transcriptionist 106a has transcribed transcription jobs having the current worktype, measured as an absolute number and/or as a percentage of total jobs transcribed by the requesting transcriptionist 106a.
   The productivity of the requesting transcriptionist 106a when transcribing jobs having the current worktype, such as may be measured by the average number of lines of text produced per hour when the requesting transcriptionist 106a transcribed jobs having the current worktype.
The amount of experience the requesting transcriptionist 106a has had in connection with transcription jobs associated with the current client, as may be measured by any one or more of the following, in any combination:
   The number of times the requesting transcriptionist 106a has transcribed transcription jobs associated with the current client, measured as an absolute number and/or as a percentage of total jobs transcribed by the requesting transcriptionist 106a.
   The productivity of the requesting transcriptionist 106a when transcribing jobs associated with the current client, such as may be measured by the average number of lines of text produced per hour when the requesting transcriptionist 106a transcribed jobs associated with the current client.
The requesting transcriptionist 106a's demonstrated understanding of jobs dictated by the current dictator, such as may be measured by document quality measures associated with jobs previously dictated by the current dictator and previously transcribed by the requesting transcriptionist 106a. This demonstrated understanding may, for example, be expressed as an absolute value or as a value that is relative to the requesting transcriptionist 106a's understanding of the current dictator relative to the requesting transcriptionist 106's understanding of other dictators. This demonstrated understanding may, for example, be derived from one or both of the following associated with documents previously transcribed by the requesting transcriptionist 106a: (1) quality assurance (QA) markers, which may be placed at locations in a document where the requesting transcriptionist 106a cannot understand what the dictator has said; and (2) transcriptionist auditing metrics, which may be generated and stored in association with documents previously transcribed by the requesting transcriptionist 106a as a result of standard auditing practices that characterize errors in those documents as, e.g., critical, major, or minor errors. Such error categories may, for example, follow definitions in the Association for Healthcare Documentation Integrity (AHDI) standards.
The requesting transcriptionist 106a's training level and/or skill level, which may be associated with the requesting transcriptionist 106a and not with any particular transcripts produced by the requesting transcriptionist 106a.
The requesting transcriptionist 106a's schedule, such as the requesting transcriptionist 106a's current and/or near-term future schedule, such as may be obtained from a scheduling system. The transcription job routing engine 102 may use such schedule information to determine whether the engine 102 should hold any of the available transcription jobs 110 for a transcriptionist who is likely to be coming online soon or, conversely, to not hold a job for a transcriptionist who is likely to be going offline soon.
The cost of having the requesting transcriptionist 106a transcribe the incoming transcription job 104, which may include, for example, the cost of performing Quality Assurance (QA) reviews on the requesting transcriptionist 106a's work.

The transcription job routing engine 102 may select the incoming transcription job 104 based on the job and transcriptionist properties described above in any of a variety of ways. For example, the transcription job routing engine 102 may assign a weight to each such property and then calculate, for each of the available transcription jobs 110, a weighted average of some or all of the properties above. The transcription job routing engine 102 may then identify a job in the available transcription jobs 110 that is associated with the highest weighted average and assign the identified transcription job 104 to the requesting transcriptionist 106a. This is merely one example of a way in which the transcription job routing engine 102 may use the job and transcriptionist properties to select the incoming transcription job 104 to route to the requesting transcriptionist 106a, and does not constitute a limitation of the present invention.

Embodiments of the present invention have a variety of advantages. For example, the system 100 and method 200 may increase the productivity of the transcriptionists 106a-c by routing transcription jobs (e.g., the incoming transcription job 104) to them that are likely to make them, and the transcriptionist population as a whole, both more productive and more likely to produce higher quality documents, by assigning transcriptionists to jobs having properties that are similar to the properties of previous transcription jobs that they have transcribed efficiently and effectively. Another advantage of the system 100 and method 200 is that, by executing automatically, they reduce the amount of human management intervention that typically occurs in existing systems, in which human managers attempt to increase transcriptionist efficiency and effectiveness by manually assigning jobs to transcriptionists.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

The term “transcriptionist,” as used herein, is not limited to any particular kind of user. Instead, the term “transcriptionist” is used herein to refer to any user who is assigned to perform any type of work in connection with a transcription job, such as transcription, coding, and scribing. As a result, a “transcriptionist,” as that term is defined herein, may or may not perform transcription. Instead, the term “transcriptionist” is used herein merely as an example and not as a limitation.

The terms “assigning,” “routing,” and “selecting a transcriptionist,” and similar terms as used herein refer to assigning a transcription job to one or more particular transcriptionists automatically. As a result of such assignment, the transcription job is available to be worked on only by the assigned transcriptionist(s) and not by other transcriptionist(s). For example, in embodiments of the present invention, when a transcription job is assigned to a single transcriptionist, that transcription job is available to be worked on only by that transcriptionist and not by other transcriptionists. Furthermore, in embodiments of the present invention, the act of assigning a transcription job to a transcriptionist is performed automatically and not, for example, in response to a transcriptionist manually selecting the transcription job from among a plurality of transcription jobs.

Embodiments of the present invention include features which are only possible and/or feasible to implement with the use of one or more computers, computer processors, and/or other elements of a computer system. Such features are either impossible or impractical to implement mentally and/or manually. For example, the system 100 and method 200 automatically analyze properties of the transcriptionists 106a-c and previous transcripts produced by those transcriptionists and use the results of this automatic analysis to automatically assign and route incoming transcription jobs to the transcriptionists 106a-c.

Embodiments of the present invention solve at least one technical problem using at least one technical solution having technical features and effects. For example, one technical problem solved by embodiments of the present invention is how to automatically (i.e., by at least one computer and without human intervention) select a transcription job from among a plurality of transcription jobs based on properties of the plurality of transcription jobs and properties of a requesting transcriptionist, where the selected transcription job, the plurality of transcription jobs, the properties of the plurality of transcription jobs, and the properties of the requesting transcriptionist are all represented by data stored in at least one non-transitory computer-readable medium. Although previous technologies exist for automatically selecting transcription jobs, they do not take into account properties of the plurality of transcription jobs and the properties of the requesting transcriptionist. As a result, such previous technologies often make a suboptimal selection of a transcription job. In contrast, embodiments of the present invention automatically (i.e., by at least one computer and without human intervention) select a transcription job from among a plurality of transcription jobs based on properties of a plurality of transcription jobs and properties of a requesting transcriptionist, such as by selecting a transcription job that is similar to transcription jobs previously worked on by the requesting transcriptionist. As a result, embodiments of the present invention select a transcription job that is a better match for the properties of the requesting transcriptionist. This automated solution is technical in nature because it uses at least one computer to select a transcription job automatically, and has the technical effect of producing as output a selected transcription job, which is transmitted over a digital communication network.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions tangibly stored on an least one non-transitory computer-readable medium, the method comprising, at a transcription job routing engine:
(A) receiving, from a requesting transcriptionist, a transcription job request;
(B) identifying a plurality of properties of a plurality of available transcription jobs;
(C) identifying a plurality of properties of the requesting transcriptionist;
(D) selecting, based on the plurality of properties of the plurality of available transcription jobs and the plurality of properties of the requesting transcriptionist, a particular one of the plurality of available transcription jobs; and
(E) assigning the selected transcription job to the requesting transcriptionist.

2. The method of claim 1, wherein the transcription job request includes an audio signal representing speech of a person.

3. The method of claim 1:
wherein the plurality of properties of the requesting transcriptionist includes a plurality of identifiers of people who dictated a plurality of transcription jobs previously worked on by the requesting transcriptionist;
wherein the plurality of properties of the plurality of available transcription jobs includes a plurality of identifiers of people who dictated the plurality of available transcription jobs; and
wherein (D) comprises selecting the particular one of the plurality of available transcription jobs based on the plurality of identifiers of people who dictated a plurality of transcription jobs previously worked on by the requesting transcriptionist and the plurality of identifiers of people who dictated the plurality of available transcription jobs.

4. The method of claim 3, wherein (D) comprises selecting the particular one of the plurality of available transcription jobs based on a number of times that the requesting transcriptionist has worked on transcription jobs dictated by the people who dictated the plurality of available transcription jobs.

5. The method of claim 1:
wherein the plurality of properties of the requesting transcriptionist includes a plurality of identifiers of work types of a plurality of transcription jobs previously worked on by the requesting transcriptionist;
wherein the plurality of properties of the plurality of available transcription jobs includes a plurality of identifiers of people who dictated the plurality of available transcription jobs; and
wherein (D) comprises selecting the particular one of the plurality of available transcription jobs based on the plurality of work types of transcription jobs previously worked on by the requesting transcriptionist and the plurality of identifiers of people who dictated the plurality of available transcription jobs.

6. The method of claim 5, wherein (D) comprises selecting the particular one of the plurality of available transcription jobs based on a number of times that the requesting transcriptionist has worked on transcription jobs having work types in the plurality of work types.

7. The method of claim 1, wherein (A) comprises receiving the transcription job request from the requesting transcriptionist over a network, and wherein (E) comprises transmitting the transcription job to the requesting transcriptionist over the network.

8. A system comprising at least one non-transitory computer readable medium containing computer program instructions executable by at least one computer processor to perform a method, the method comprising, at a transcription job routing engine:
(A) receiving, from a requesting transcriptionist, a transcription job request;
(B) identifying a plurality of properties of a plurality of available transcription jobs;
(C) identifying a plurality of properties of the requesting transcriptionist;
(D) selecting, based on the plurality of properties of the plurality of available transcription jobs and the plurality of properties of the requesting transcriptionist, a particular one of the plurality of available transcription jobs; and
(E) assigning the selected transcription job to the requesting transcriptionist.

9. The system of claim 8, wherein the transcription job request includes an audio signal representing speech of a person.

10. The system of claim 8:
wherein the plurality of properties of the requesting transcriptionist includes a plurality of identifiers of people who dictated a plurality of transcription jobs previously worked on by the requesting transcriptionist;
wherein the plurality of properties of the plurality of available transcription jobs includes a plurality of identifiers of people who dictated the plurality of available transcription jobs; and
wherein (D) comprises selecting the particular one of the plurality of available transcription jobs based on the plurality of identifiers of people who dictated a plurality of transcription jobs previously worked on by the requesting transcriptionist and the plurality of identifiers of people who dictated the plurality of available transcription jobs.

11. The system of claim 10, wherein (D) comprises selecting the particular one of the plurality of available transcription jobs based on a number of times that the requesting transcriptionist has worked on transcription jobs dictated by the people who dictated the plurality of available transcription jobs.

12. The system of claim 8:
wherein the plurality of properties of the requesting transcriptionist includes a plurality of identifiers of work types of a plurality of transcription jobs previously worked on by the requesting transcriptionist;
wherein the plurality of properties of the plurality of available transcription jobs includes a plurality of identifiers of people who dictated the plurality of available transcription jobs; and
wherein (D) comprises selecting the particular one of the plurality of available transcription jobs based on the plurality of work types of transcription jobs previously worked on by the requesting transcriptionist and the plurality of identifiers of people who dictated the plurality of available transcription jobs.

13. The system of claim 12, wherein (D) comprises selecting the particular one of the plurality of available transcription jobs based on a number of times that the requesting transcriptionist has worked on transcription jobs having work types in the plurality of work types.

14. The system of claim 8, wherein (A) comprises receiving the transcription job request from the requesting transcriptionist over a network, and wherein (E) comprises transmitting the transcription job to the requesting transcriptionist over the network.
